(19) United States
(12) Patent Application Publication
(10) Pub. No.: US 2026/0290046 A1
(43) Pub. Date: Sep. 24, 2026

(54) INFORMATION MANAGEMENT APPARATUS, INFORMATION MANAGEMENT METHOD, AND NON-TRANSITORY COMPUTER READABLE MEDIUM FOR INFORMATION MANAGEMENT PROGRAM

(71) Applicant: Honda Motor Co., Ltd., Tokyo (JP)

(72) Inventors: Ko Uchida, Tokyo (JP); Hiroshi Honda, Tokyo (JP); Tameaki Honda, Tokyo (JP); Kazuki Yoshigai, Tokyo (JP); Shotaro Nishimura, Tokyo (JP); Yosuke Fuchiwaki, Tokyo (JP)

(21) Appl. No.: 19/568,982

(22) Filed: Mar. 17, 2026

(30) Foreign Application Priority Data
Mar. 21, 2025 (JP) 2025-046214

(51) Int. Cl. G06V 20/59; G06V 20/56; G06V 40/16; G10L 15/08; G10L 25/63

(52) U.S. Cl. CPC G06V 20/597; G06V 20/56; G06V 40/174; G10L 15/08; G10L 25/63; G10L 2015/088

(57) ABSTRACT

An information management apparatus includes: an imaging device capturing images of a vehicle interior and surroundings of a vehicle; an audio input device provided in the vehicle interior; and a microprocessor. The microprocessor performs: generating, based on image data acquired by the imaging device and audio data acquired by the audio input device, video data including the image data and the audio data; detecting, based on the image data or the audio data, a specific scene including a predetermined emotion of an occupant in the vehicle interior represented by at least one of a facial expression of the occupant and a voice uttered by the occupant; generating, when the specific scene is detected, additional information indicating a situation inside the vehicle interior or outside the vehicle in the specific scene; and outputting recording data in which the video data and the additional information are associated.

### CROSS-REFERENCE TO RELATED APPLICATION

This application is based upon and claims the benefit of priority from Japanese Patent Application No. 2025-046214 filed on Mar 21, 2025, the content of which is incorporated herein by reference.

### BACKGROUND

### Technical Field

The present disclosure relates to an information management apparatus, an information management method, and a non-transitory computer readable medium storing information management program for managing information.

### Related Art

Conventionally, there is known a device configured to automatically arrange an image selected from among images stored in a storage medium in a frame area provided in a page of an electronic album (for example, see JP 2020-154579 A). In the device disclosed in JP 2020-154579 A, a specific person or animal is specified as a search condition, and an image that satisfies the search condition is selected from among the images stored in the storage medium.

However, as in the device disclosed in JP 2020-154579 A, if an image to be arranged on the album is selected merely on the basis of the search condition, the selected image does not necessarily include a scene that is memorable to the user; therefore, it is not possible to adequately assist the user in looking back on memories.

### SUMMARY

An aspect of the present invention is an information management apparatus including: an imaging device configured to capture images of at least one of an interior of a vehicle and surroundings of the vehicle; an audio input device provided in the interior of the vehicle; a microprocessor; and a memory connected to the microprocessor. The microprocessor is configured to perform: generating, based on image data acquired by the imaging device and audio data acquired by the audio input device, video data including the image data and the audio data; detecting, based on the image data or the audio data, a specific scene including a predetermined emotion of an occupant in the interior of the vehicle represented by at least one of a facial expression of the occupant and a voice uttered by the occupant; generating, when the specific scene is detected, additional information indicating a situation in the interior of the vehicle or outside the vehicle in the specific scene; and outputting recording data in which the video data and the additional information are associated with each other..

Another aspect of the present invention is an information management method for an information management apparatus including an imaging device configured to capture images of at least one of an interior of a vehicle and surroundings of the vehicle, and an audio input device provided in the interior of the vehicle, the method including: generating video data including the image data and the audio data based on image data acquired by the imaging device and audio data acquired by the audio input device; detecting, based on the image data or the audio data, a specific scene including a predetermined emotion of an occupant represented by at least one of a facial expression of the occupant in the interior of the vehicle and a voice uttered by the occupant; generating additional information corresponding to the specific scene when the specific scene is detected; and outputting recording data in which the video data and the additional information are associated with each other.

Still another aspect of the present invention is a computer-readable storage medium storing an information management program for causing a computer to execute the program, the computer including an imaging device configured to capture images of at least one of an interior of a vehicle and surroundings of the vehicle, and an audio input device provided in the interior of the vehicle. The information management program causes the computer to perform: generating video data including the image data and the audio data based on image data acquired by the imaging device and audio data acquired by the audio input device; detecting, based on the image data or the audio data, a specific scene including a predetermined emotion of an occupant represented by at least one of a facial expression of the occupant in the interior of the vehicle and a voice uttered by the occupant; generating additional information corresponding to the specific scene when the specific scene is detected; and outputting recording data in which the video data and the additional information are associated with each other.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of an information management system including an information management apparatus according to an embodiment of the present invention;

FIG. 2 is: a block diagram illustrating a main configuration of the information management apparatus illustrated in FIG. 1;

FIG. 3 is a diagram showing an example of an emotion of an occupant recognized by a detection unit;

FIG. 4A is a diagram for describing generation of additional information;

FIG. 4B is a diagram for describing the generation of additional information;

FIG. 4C is a diagram for describing the generation of additional information;

FIG. 5A is a diagram for describing the generation of additional information;

FIG. 5B is a diagram for describing the generation of additional information; and

FIG. 6 is a flowchart illustrating an example of processing executed by the controller in FIG. 2.

### DETAILED DESCRIPTION

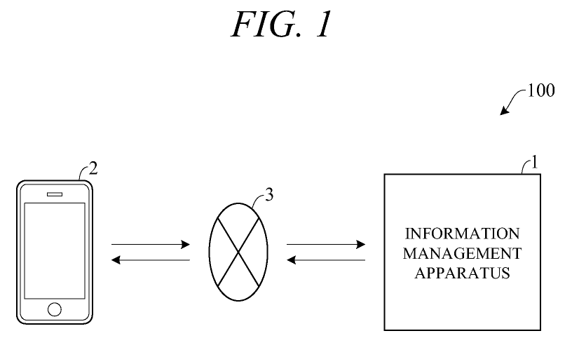

Hereinafter, an embodiment of the invention will be described with reference to the drawings. An information management apparatus according to the embodiment of the present invention is a device for managing video data generated on the basis of image data acquired by a vehicle-mounted camera and audio data acquired by a vehicle-mounted mic. Note that a vehicle to which the information management apparatus according to the present embodiment is applied may be referred to as a subject vehicle so as to be distinguished from other vehicles. FIG. 1 is a block diagram schematically illustrating an overall configuration of an information management system 100 including an information management apparatus 1 according to the present embodiment. As illustrated in FIG. 1, the information management system 100 includes the information management apparatus 1 and a user terminal 2.

The information management apparatus 1 and the user terminal 2 are communicably connected via a communication network 3. The communication network 3 includes not only a public wireless communication network, such as the Internet network or a mobile communication network, but also a closed communication network provided for each predetermined management region, such as a wireless LAN, Wi-Fi (registered trademark), or Bluetooth (registered trademark).

The user terminal 2 is a communication terminal, such as a smartphone, and is used by a user of the subject vehicle, such as an occupant. Note that, although a single user terminal 2 is illustrated in FIG. 1, the information management system 100 includes a user terminal 2 corresponding to each user.

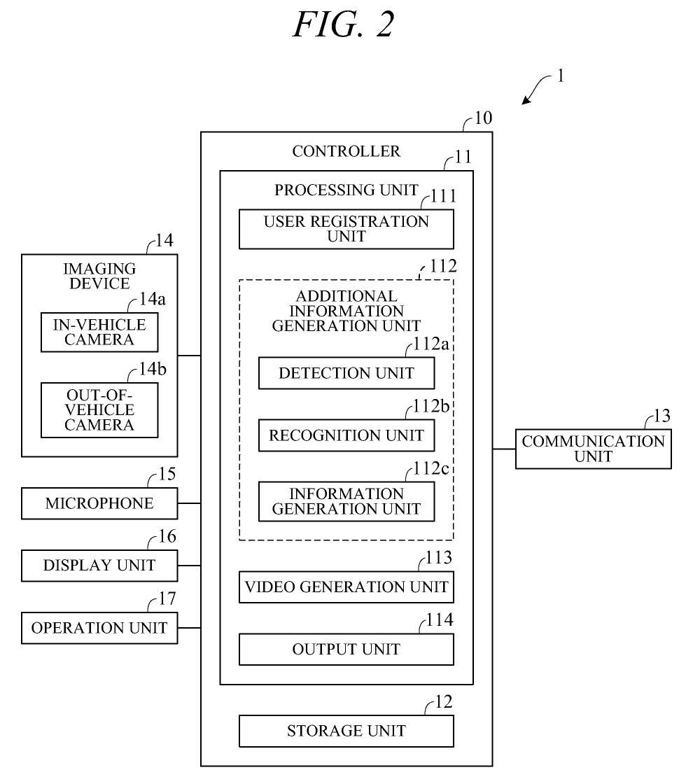

FIG. 2 is a block diagram illustrating a main configuration of the information management apparatus 1 illustrated in FIG. 1. The information management apparatus 1 includes a controller 10, a communication unit 13, an imaging device 14, a microphone (hereinafter, simply referred to as a mic) 15, a display unit 16, and an operation unit 17. The communication unit 13 is a communication interface that connects the information management apparatus 1 to the communication network 3. The information management apparatus 1 transmits and receives information to and from the user terminal 2 or the like connected to the communication network 3 via the communication unit 13.

The imaging device 14 includes a camera 14a that captures an interior of the subject vehicle (hereinafter, referred to as an in-vehicle camera) and a camera 14b that captures surroundings of the subject vehicle (hereinafter, referred to as an out-of-vehicle camera). Each of the cameras 14a and 14b includes an imaging element such as a CCD or a CMOS. Image data captured by the cameras 14a and 14b is output to a processing unit 11. The mic 15 receives in-vehicle audio as an audio signal. The audio signal input by the mic 15 is output to the processing unit 11 as audio data via an A/D converter (not illustrated).

The display unit 16 includes a display device provided with a touch panel, such as a liquid crystal display or an organic EL display. The operation unit 17 includes the touch panel provided in the display unit 16, and is capable of receiving various instructions from the user. Note that the operation unit 17 may include an input device such as a switch or a button.

The controller 10 includes a computer provided with the processing unit 11 such as a CPU (microprocessor), a storage unit 12 such as a ROM and a RAM, and other peripheral circuits (not illustrated) such as an I/O interface. The processing unit 11 functions as a user registration unit 111, an additional information generation unit 112, a video generation unit 113, and an output unit 114 by executing a program stored in storage unit 12.

The user registration unit 111 displays a registration request screen (not illustrated) for requesting registration of user information on the display unit 16. The user information is information in which identification information (such as a name or a nickname), face image data, and voiceprint data of each user are associated with each other.

When the registration request screen is displayed on the display unit 16, the user operates the operation unit 17 to input the identification information of the user on the registration request screen. Further, the user operates the operation unit 17 to cause the in-vehicle camera 14a to capture the user’s face. Furthermore, the user inputs their voice into the mic 15.

The user registration unit 111 stores, in the storage unit 12, the identification information input via the registration request screen. Further, the user registration unit 111 stores the face image data acquired by the camera 14a in the storage unit 12 in association with the identification information. Furthermore, the user registration unit 111 extracts the voiceprint data from the user’s voice input via the mic 15, and stores the voiceprint data in the storage unit 12 in association with the identification information. As a result, the user information is registered. Note that the method for registering the user information is not limited thereto, and for example, the user information received from an external device such as the user terminal 2 may be stored in the storage unit 12.

The additional information generation unit 112 generates additional information using a machine learning model with the image data acquired by the imaging device 14 and the audio data acquired by the mic 15 as inputs. The machine learning model includes an emotion classification model, a speaker recognition model, a speaker separation model, a multimodal large language model (LLM), and the like. Note that the machine learning model may be stored in the storage unit 12 or may be stored in an external device (e.g., a server device or a storage device) connected to the information management apparatus 1 via the communication network 3.

The additional information generation unit 112 includes a detection unit 112a, a recognition unit 112b, and an information generation unit 112c. The detection unit 112a detects a specific scene on the basis of the image data acquired by the imaging device 14 or the audio data acquired by the mic 15. The specific scene is a scene including a predetermined emotion of the occupant in the vehicle, the predetermined emotion being represented by at least one of a facial expression of the occupant and a voice uttered by the occupant, and is a scene in which the predetermined emotion of the occupant has changed by a predetermined degree or more. The emotion of the occupant includes excitement (Excited), surprise (Surprised), happiness (Happy), anger (Angry), and sadness (Sad). The predetermined emotion includes one or a plurality of emotions specified in advance from the above five emotions. Note that the emotion of the occupant may include an emotion other than the above five emotions.

Here, the processing of detecting the specific scene (hereinafter, referred to as specific scene detection processing) executed by the detection unit 112a will be described. The detection unit 112a recognizes an emotion of the occupant represented by the facial expression of the occupant on the basis of the image data capturing the interior of the vehicle (hereinafter, also referred to as in-vehicle image data) acquired by the imaging device 14. Further, the detection unit 112a recognizes an emotion of the occupant represented by an amount of change in utterance volume of the occupant per predetermined time on the basis of the audio data (hereinafter, also referred to as in-vehicle audio data) acquired by the mic 15. Furthermore, the detection unit 112a recognizes an emotion of the occupant represented by a voice of the occupant on the basis of the in-vehicle audio data.

The machine learning model, more specifically, the emotion classification model is used to recognize the emotion of the occupant based on the in-vehicle image data and the in-vehicle audio data. The emotion classification model uses the in-vehicle image data and the in-vehicle audio data as inputs to estimate the emotion of the occupant represented by three elements: the facial expression of the occupant; the amount of change in utterance volume of the occupant per predetermined time; and the voice of the occupant. Specifically, the emotion classification model calculates, for each of the above elements, numerical emotion scores, one for each of the emotions of the occupant (“excitement”, “surprise”, “happiness”, “anger”, and “sadness”), ranging from 0.0 (none) to 1.0 (maximum). Note that the emotion of the occupant may be estimated on the basis of elements other than the above three elements.

The detection unit 112a recognizes the intensity of each emotion of the occupant on the basis of the emotion scores calculated by the emotion classification model. More specifically, the detection unit 112a calculates an average value of the emotion scores corresponding to each element. For example, when the emotion scores of “happiness” represented by the facial expression of the occupant, the amount of change in utterance volume of the occupant per predetermined time, and the voice of the occupant are 0.8, 0.6, and 0.7, respectively, 0.7 is calculated as the average value of the emotion scores of “happiness”. The detection unit 112a calculates the average value of emotion scores for each emotion, and recognizes the intensity of each emotion of the occupant on the basis of the calculation result. Note that the detection unit 112a may recognize the intensity of each emotion of the occupant on the basis of a total value of the emotion scores corresponding to each element. Further, the detection unit 112a may recognize the intensity of each emotion of the occupant on the basis of the emotion scores corresponding to any one of the above three elements.

Further, the detection unit 112a detects a time point at which the predetermined emotion of the occupant has changed by a predetermined degree or more (hereinafter, referred to as an emotion change time point) on the basis of the intensity of each recognized emotion. More specifically, the detection unit 112a detects, as the emotion change time point, a time point at which the emotion score of the predetermined emotion (the average value of the emotion scores corresponding to each element) has changed by a predetermined amount or more. In a case where a plurality of emotions are specified as the predetermined emotion, an emotion change time point corresponding to each emotion is detected.

In a case where a plurality of users (for example, four people: X, Y, Z, and W) are in the subject vehicle, the detection unit 112a inputs, into the emotion classification model, the user information stored in the storage unit 12 in addition to the in-vehicle image data and the in-vehicle audio data.

The emotion classification model calculates the five emotion scores for each occupant with the in-vehicle image data, the in-vehicle audio data, and the user information as inputs. The detection unit 112a detects, as the emotion change time point, a time point at which the emotion score of the predetermined emotion of any one of the occupants has changed by a predetermined amount or more.

Note that the detection unit 112a may detect, as the emotion change time point, a time point at which the emotion score of the predetermined emotion of a specific occupant specified by the user has changed by a predetermined amount or more. Further, the detection unit 112a may calculate an average value or a total value of the emotion scores of all the occupants and detect, as the emotion change time point, a time point at which the average value or the total value has changed by a predetermined amount or more.

When the emotion change time point is detected, the detection unit 112a detects a predetermined period including the emotion change time point as a specific scene. Note that the predetermined period may be a period with the emotion change time point as a start point or an end point, or may be a period with the emotion change time point as any time point between the start point and the end point. Hereinafter, this predetermined period is also referred to as a recording period.

When the specific scene is detected by the detection unit 112a, the recognition unit 112b separates the in-vehicle audio data acquired by the mic 15 during the recording period into speaker-separated audio data using the machine learning model, more specifically, the speaker recognition model and the speaker separation model. The recognition unit 112b classifies each speaker-separated audio data by occupant on the basis of the voiceprint data included in the user information. The recognition unit 112b further recognizes the content of the conversation of each occupant on the basis of the audio data classified by occupant (hereinafter, referred to as occupant audio data) using the machine learning model, more specifically, a voice recognition model.

The information generation unit 112c generates additional information in which the situation inside or outside the vehicle in the specific scene is recorded on the basis of the recognition result of the recognition unit 112b. Specifically, the information generation unit 112c first determines whether the conversation of the occupant includes a phrase related to an out-of-vehicle environment (hereinafter, referred to as an out-of-vehicle environment phrase) on the basis of the content of the conversation of the occupant recognized by the recognition unit 112b.

When determining that the out-of-vehicle environment phrase is included in the conversation of the occupant, the information generation unit 112c generates additional information on the basis of out-of-vehicle image data acquired by the imaging device 14 during the recording period and the in-vehicle audio data acquired by the mic 15 during the recording period. Specifically, the information generation unit 112c generates the additional information using the machine learning model, more specifically, the multimodal LLM (hereinafter, simply referred to as an LLM) with the in-vehicle audio data and the out-of-vehicle image data as inputs. Note that, in a case where a plurality of occupants are in the vehicle, the information generation unit 112c inputs, into the multimodal LLM, user information of an occupant whose emotion change has been detected, more specifically, an occupant whose predetermined emotion has changed by a predetermined degree or more, in addition to the in-vehicle audio data and the out-of-vehicle image data.

The multimodal LLM is a machine learning model that analyzes the content of input audio data, image data, and text data and generates text data related to them. The multimodal LLM generates additional information in which the identification information, utterance content, and utterance intent of the occupant whose emotion change has been detected are written in natural language on the basis of the input in-vehicle audio, out-of-vehicle image data, and user information.

When determining that the out-of-vehicle environment phrase is not included in the conversation of the occupant, the information generation unit 112c further determines whether there is a relationship between the content of the conversation recognized by the recognition unit 112b and the predetermined emotion of the occupant, as represented by the facial expression of the occupant, recognized by the specific scene detection processing.

When determining that there is no relationship between the predetermined emotion of the occupant and the content of the conversation, the information generation unit 112c generates the additional information on the basis of the out-of-vehicle image data acquired by the imaging device 14 during the recording period. Specifically, the information generation unit 112c inputs the out-of-vehicle image data into the multimodal LLM, and acquires text data generated by the multimodal LLM as the additional information.

On the other hand, when determining that there is a relationship between the predetermined emotion of the occupant and the content of the conversation, the information generation unit 112c generates the additional information on the basis of the in-vehicle image data and the in-vehicle audio data acquired during the recording period. Specifically, the information generation unit 112c inputs the in-vehicle audio data and the in-vehicle image data into the multimodal LLM, and acquires text data generated by the multimodal LLM as the additional information.

Note that, in a case where a plurality of occupants are in the vehicle, the information generation unit 112c may input, into the multimodal LLM, occupant audio data corresponding to an occupant whose predetermined emotion has changed by a predetermined degree or more instead of the in-vehicle audio data.

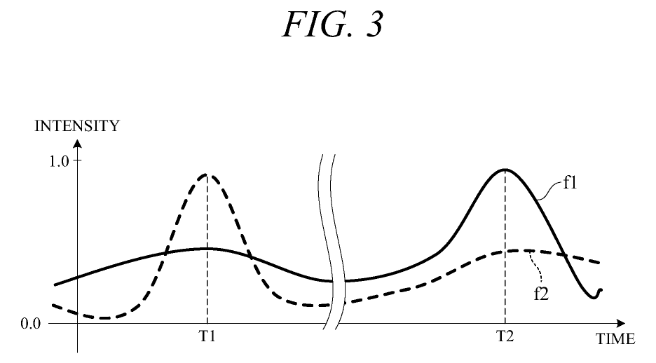

FIG. 3 is a diagram showing an example of the emotion of the occupant (X) recognized by the detection unit 112a. In FIG. 3, the horizontal axis represents time, and the vertical axis represents emotion intensity. Feature f1 represents the emotion score of “excitement”, and feature f2 represents the emotion score of “surprise”. As described above, the emotion of the occupant includes “happiness”, “anger”, “sadness”, and the like, but in the example shown in FIG. 3, only the emotion scores of “excitement” and “surprise” specified as the predetermined emotion are shown for the sake of simplifying the description. Times T1 and T2 are emotion change time points. At time T1, the emotion score of “surprise” exhibits a large change (increase). Further, at time T2, the emotion score of “excitement” exhibits a large change (increase).

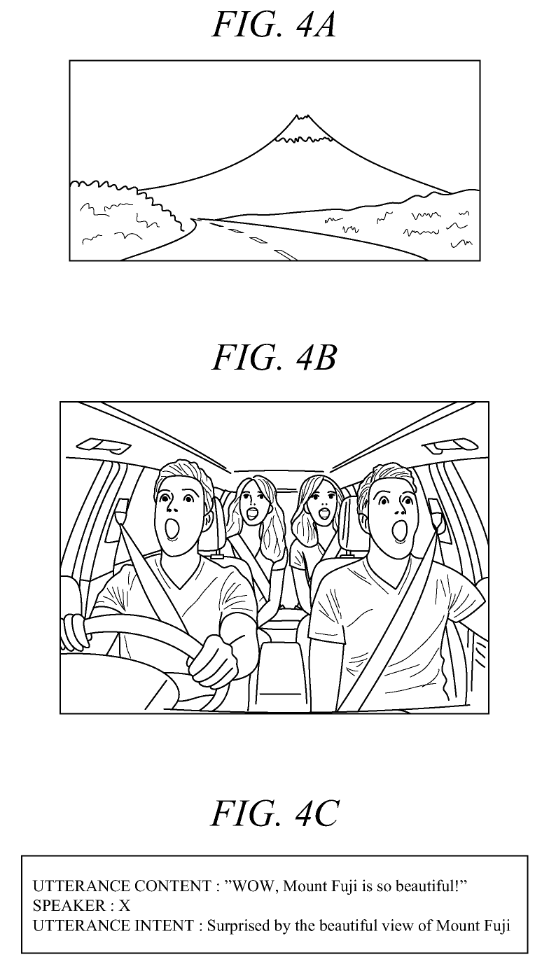

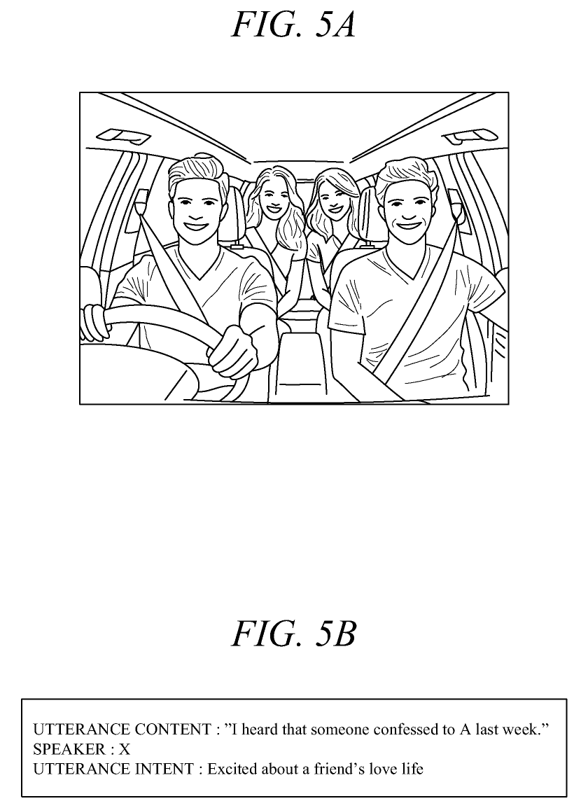

FIGS. 4A to 4C and FIGS. 5A, and 5B are diagrams for describing the generation of additional information. FIG. 4A illustrates an out-of-vehicle image at time T1 in FIG. 3, and FIG. 4B illustrates an in-vehicle image at time T2. At the time T1, when the occupant X looks at beautiful Mount Fuji in front of the subject vehicle and says “WOW, Mount Fuji is so beautiful!”, the utterance content includes a phrase related to the out-of-vehicle environment. Therefore, the additional information is generated on the basis of the out-of-vehicle image data (FIG. 4A) and the in-vehicle audio data. FIG. 4C illustrates an example of the additional information generated at this time.

As illustrated in FIG. 4C, the additional information corresponding to time T1 includes text data from which the speaker (“X”) can be identified and text data indicating an utterance intent (“Surprised by the beautiful view of Mount Fuji”), together with text data indicating the above utterance content.

FIG. 5A illustrates an in-vehicle image at time T2 shown in FIG. 3. At time T2, in a case where the occupant X says “I heard that someone confessed to A last week.” to the other occupants in an excited manner, the utterance content does not include a phrase related to the out-of-vehicle environment, but there is a relationship between the utterance content of the occupant X and the emotion of the occupant X. More specifically, it is assumed that the emotion score of “excitement” of the occupant X at time T2 is increased due to the utterance content. Therefore, the additional information is generated on the basis of the in-vehicle image data (FIG. 5A) and the in-vehicle audio data. FIG. 5B illustrates an example of the additional information generated at this time.

As illustrated in FIG. 5B, the additional information corresponding to time T2 includes text data from which the speaker (“X”) can be identified and text data indicating an utterance intent (“Excited about a friend’s love life”), together with text data indicating the above utterance content.

The video generation unit 113 generates video data including the image data acquired by the imaging device 14 and the audio data acquired by the mic 15. The video generation unit 113 further generates record data in which the generated video data and the additional information generated by the information generation unit 112c are associated with each other (hereinafter, also referred to as album data). More specifically, the video generation unit 113 generates, for each specific scene detected by the detection unit 112a, record data in which the video data corresponding to the specific scene and the additional information are associated with each other. This enables generating record data including memorable scenes. Further, the size of the record data can be reduced by excluding video data that does not correspond to the specific scene from the record data.

Further, the video generation unit 113 has a plurality of generation modes, and generates record data in accordance with one of the generation modes. As an example of the generation modes, there is a mode of generating record data corresponding to a specific scene in which the emotion score of a specific emotion (e.g., “sadness”) is greater than or equal to a predetermined threshold. Note that the above specific emotion may be specified by the user. Further, the above emotion score may be a score corresponding to a specific occupant (e.g., X), or may be an average score or a total score of all the occupants.

Further, as another example, there is a mode of generating record data corresponding to a specific scene including a predetermined emotion of a specific occupant. Note that the above specific occupant may be specified by the user.

The output unit 114 outputs the record data generated by the video generation unit 113 to the storage unit 12. As a result, the record data is stored in the storage unit 12. Note that the output unit 114 may output the record data to an external device (e.g., a server device or a storage device) via the communication unit 13. Further, the output unit 114 may read the record data from the storage unit 12 and output (transmit) the record data to the user terminal 2 in accordance with a transmission command from the user terminal 2. In this case, the user can look back on memories of drives and trips by displaying the record data on a display unit (not illustrated) of the user terminal 2.

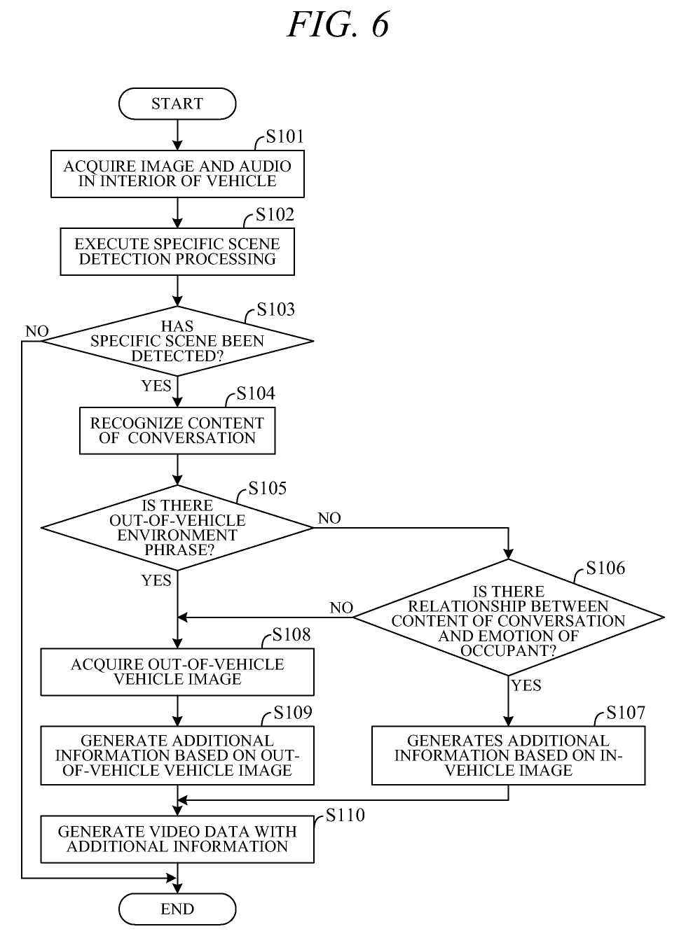

FIG. 6 is a flowchart illustrating an example of processing executed by the controller 10 of the information management apparatus 1 in accordance with a predetermined program. The processing illustrated in the flowchart is started when the controller 10 is activated, and is repeated at a predetermined cycle.

First, in step S101, the controller 10 acquires in-vehicle image data via the imaging device 14. The controller 10 further acquires in-vehicle audio data via the mic 15. In step S102, the controller 10 executes the specific scene detection processing using the in-vehicle image data and the in-vehicle audio data acquired in step S101.

In step S103, the controller 10 determines whether a specific scene has been detected in the specific scene detection processing in step S102. In a case where the determination in step S103 is negative, the controller 10 terminates the processing. In a case where the determination in step S103 is affirmative, the controller 10 recognizes the content of the conversation of the occupant on the basis of the in-vehicle audio data in step S104. In step S105, it is determined whether the conversation of the occupant includes an out-of-vehicle environment phrase.

In a case where the determination in step S105 is negative, the controller 10 determines whether there is a relationship between the conversation of the occupant and the emotion of the occupant in step S106. Note that the emotion of the occupant is recognized in the specific scene detection processing in step S102. In a case where the determination in step S106 is negative, the controller 10 proceeds to step S108. In a case where the determination in step S106 is affirmative, the controller 10 generates additional information using the multimodal LLM with the in-vehicle image data and the in-vehicle audio data as inputs in step S107, and proceeds to step S110.

In a case where the determination in step S105 is affirmative, the controller 10 acquires out-of-vehicle image data via the imaging device 14 in step S108. In step S109, the controller 10 generates additional information using the multimodal LLM with the out-of-vehicle image data and the in-vehicle audio data as inputs, and proceeds to step S110.

In step S110, the controller 10 generates video data corresponding to the specific scene on the basis of the in-vehicle image data and the in-vehicle audio data. The controller 10 generates record data in which the generated video data and the additional information generated in step S107 or step S109 are associated with each other. The controller 10 stores the generated record data in storage unit 12. In a case where record data already exists in the storage unit 12, the controller 10 concatenates the generated record data in chronological order with the existing record data. The record data concatenated in chronological order is stored in the storage unit 12 for each travel (shopping, drive, trip, etc.).

Note that, in a case where the additional information is generated on the basis of the out-of-vehicle image data, the controller 10 may generate video data corresponding to the specific scene on the basis of the in-vehicle image data, the out-of-vehicle image data, and the in-vehicle audio data in step S110.

According to the above-described embodiment, the following effects can be achieved.
(1) An information management apparatus 1 includes: an imaging device 14 configured to capture at least one of an interior of a vehicle or surroundings of the vehicle; a mic 15 serving as an audio input device provided in the vehicle; and a video generation unit 113 configured to generate, on the basis of image data acquired by the imaging device 14 and audio data acquired by the mic 15, video data including the image data and the audio data. The information management apparatus 1 further includes: a detection unit 112a configured to detect a specific scene including a predetermined emotion of an occupant in the vehicle represented by at least one of a facial expression of the occupant and a voice uttered by the occupant on the basis of the image data or the audio data; an information generation unit 112c configured to generate, when the specific scene is detected by the detection unit 112a, additional information indicating a situation inside or outside the vehicle in the specific scene; and an output unit 114 serving as an information recording unit configured to output record data in which the video data and the additional information are associated with each other. This configuration enables the additional information indicating the situation of a memorable scene to be stored in the record data together with the video data, thereby enabling the creation of record data reflecting a user’s intent. As a result, the user can easily look back on memories using the record data. Further, by including the additional information in the record data, editing work such as extracting video data of a memorable scene from the record data is facilitated.
(2) The imaging device 14 captures the interior of the vehicle to acquire in-vehicle image data as first image data, and captures the surroundings of the vehicle to acquire out-of-vehicle image data as second image data. The information management apparatus 1 further includes a recognition unit 112b configured to recognize, when the specific scene is detected, content of a conversation of the occupant on the basis of the audio data acquired by the mic 15. The information generation unit 112c determines whether the conversation of the occupant includes a phrase related to an out-of-vehicle environment on the basis of the recognition result of the recognition unit 112b. When determining that the conversation of the occupant includes a phrase related to the out-of-vehicle environment, the information generation unit 112c generates the additional information on the basis of the out-of-vehicle image data. This configuration enables the user to easily look back on memories based on the situation outside the vehicle using the record data.
(3) The information generation unit 112c further determines whether there is a relationship between the content of the conversation recognized by the recognition unit 112b and the predetermined emotion of the occupant included in the specific scene, and generates, when determining that there is no relationship between the content of the conversation and the predetermined emotion, the additional information on the basis of the out-of-vehicle image data. This configuration enables memorable scenes based on the situation outside the vehicle to be appropriately recorded.
(4) When determining that the conversation does not include a phrase related to the out-of-vehicle environment and determining that there is a relationship between the emotion of the occupant and the content of the conversation, the information generation unit 112c generates the additional information on the basis of the in-vehicle image data. This configuration enables memorable scenes based on the situation inside the vehicle to be appropriately recorded.
(5) The detection unit 112a recognizes a facial expression representing the emotion of the occupant on the basis of the image data acquired by the imaging device 14, recognizes an amount of change in utterance volume per predetermined time and a voice representing the emotion of the occupant on the basis of the audio data acquired by the mic 15, and further detects the specific scene on the basis of the recognized facial expression of the occupant, the recognized amount of change in utterance volume of the occupant per predetermined time, and the recognized voice of the occupant. More specifically, the detection unit 112a detects the specific scene on the basis of the facial expression of the occupant, the amount of change in utterance volume of the occupant per predetermined time, or a change in emotion represented by the voice of the occupant. This configuration enables the user to easily look back on memories based on changes in the user’s own emotion using the record data.
(6) The information generation unit 112c generates, as the additional information, information indicating a situation inside or outside the vehicle during a predetermined period including a time point at which the specific scene is detected (the emotion change time point described above). This configuration enables the situation inside or outside the vehicle to be recorded not only at the time when a change in emotion is detected but also during a certain period including that time; therefore, it becomes easy to look back on memories using the record data.
(7) The video generation unit 113 has a plurality of generation modes, and generates the record data in accordance with one of the plurality of generation modes. This configuration enables the generation of record data tailored to a user’s needs.
(8) The information generation unit 112c generates the additional information using a large language model (LLM) with information indicating the specific scene detected by the detection unit 112a as an input. This configuration enables the recording of the additional information in natural language, and enables the user to look back on memories more easily.

The above embodiment may be modified into various forms. Hereinafter, modifications will be described. In the above embodiment, the video generation unit 113 generates the record data each time the specific scene is detected while the controller 10 is in operation. The video generation unit, however, may read the in-vehicle image data, the in-vehicle audio data, and the out-of-vehicle image data from the storage unit 12 after a predetermined time has elapsed since the subject vehicle was powered off, and generate the record data on the basis of the read data. This configuration enables the generation of record data corresponding to each travel of the vehicle (shopping, drive, trip, etc.), and enables the user to easily look back on memories of each travel. Further, by starting the generation of record data after a predetermined time has elapsed since the power was turned off, unnecessary generation of record data can be suppressed when the vehicle is temporarily stopped or parked at a service area, a store, or the like.

Further, in the above embodiment, the detection unit 112a detects a scene in which the predetermined emotion of the occupant has changed by a predetermined degree or more as the specific scene. The user, however, may be allowed to specify which emotion is used as a reference for detecting the specific scene.

Furthermore, in the above embodiment, the imaging device 14 including the in-vehicle camera 14a and the out-of-vehicle camera 14b has been described as an example. The imaging device, however, may include a single camera. For example, the imaging device may include an omnidirectional camera capable of capturing a 360-degree range or a drive recorder capable of capturing the front and rear.

As another aspect, the information management apparatus according to the above embodiment may be configured as an information management method for managing video data generated on the basis of image data acquired by a vehicle-mounted camera configured to capture at least one of an interior of a vehicle and surroundings of the vehicle and audio data acquired by a vehicle-mounted mic configured to collect in-vehicle audio. That is, the information management method for the information management apparatus including: an imaging device configured to capture an interior of a vehicle; and an audio input device provided in the vehicle may also be configured as an information management method including: generating, on the basis of image data acquired by the imaging device and audio data acquired by the audio input device, video data including the image data and the audio data; detecting a specific scene including a predetermined emotion of an occupant in the vehicle represented by at least one of a facial expression of the occupant and a voice uttered by the occupant on the basis of the image data or the audio data; generating, when the specific scene is detected, additional information corresponding to the specific scene; and outputting record data in which the video data and the additional information are associated with each other.

Furthermore, the present invention may also be configured by replacing the above information management method with a program for causing a computer to execute processing of managing video data generated on the basis of image data acquired by a vehicle-mounted camera configured to capture an interior of a vehicle and audio data acquired by a vehicle-mounted mic configured to collect in-vehicle audio. Furthermore, the present invention may also be configured by replacing the program with a computer-readable storage medium in which the program is recorded.

The above embodiment can be combined as desired with one or more of the aforesaid modifications. The modifications can also be combined with one another.

According to the present invention, it is possible to create album data reflecting a user’s intent and to assist the user in looking back on memories.

Above, while the present invention has been described with reference to the preferred embodiments thereof, it will be understood, by those skilled in the art, that various changes and modifications may be made thereto without departing from the scope of the appended claims.

What is claimed is:

1. An information management apparatus comprising:
an imaging device configured to capture images of at least one of an interior of a vehicle and surroundings of the vehicle;
an audio input device provided in the interior of the vehicle;
a microprocessor; and a memory connected to the microprocessor, wherein
the microprocessor is configured to perform:
generating, based on image data acquired by the imaging device and audio data acquired by the audio input device, video data including the image data and the audio data;
detecting, based on the image data or the audio data, a specific scene including a predetermined emotion of an occupant in the interior of the vehicle represented by at least one of a facial expression of the occupant and a voice uttered by the occupant;
generating, when the specific scene is detected, additional information indicating a situation in the interior of the vehicle or outside the vehicle in the specific scene; and
outputting recording data in which the video data and the additional information are associated with each other.

2. The information management apparatus according to claim 1, wherein
the imaging device captures images of the interior of the vehicle to acquire first image data and captures images of the surroundings of the vehicle to acquire second image data,
the microprocessor is further configured to perform:
when the specific scene is detected, recognizing content of a conversation of the occupant based on the audio data acquired by the audio input device,
determining, based on a recognition result in the recognizing, whether the conversation includes a phrase related to an environment outside the vehicle; and
generating the additional information based on the second image data when it is determined that the conversation includes a phrase related to the environment outside the vehicle.

3. The information management apparatus according to claim 2, wherein
the microprocessor is further configured to perform:
determining whether there is a relevance between the content of the conversation recognized in the recognizing and the predetermined emotion included in the specific scene; and
generating the additional information based on the second image data when it is determined that there is no relevance between the content of the conversation and the predetermined emotion.

4. The information management apparatus according to claim 3, wherein
the microprocessor is further configured to perform:
the generating of the additional information including generating the additional information based on the first image data when it is determined that the conversation does not include a phrase related to the environment outside the vehicle and it is determined that there is a relevance between the emotion of the occupant and the content of the conversation.

5. The information management apparatus according to claim 1, wherein
the microprocessor is further configured to perform:
recognizing a facial expression representing an emotion of the occupant based on the image data acquired by the imaging device;
recognizing an amount of change in utterance volume per predetermined time and a voice representing an emotion of the occupant based on the audio data acquired by the audio input device; and
detecting the specific scene based on the facial expression, the amount of change in utterance volume, and the voice.

6. The information management apparatus according to claim 5, wherein
the microprocessor is configured to perform:
the detecting including detecting the specific scene based on a change in the emotion represented by the facial expression, the amount of change in utterance volume, or the voice.

7. The information management apparatus according to claim 1, wherein
the microprocessor is further configured to perform:
the generating of the additional information including generating, as the additional information, information indicating a situation in the interior of the vehicle or outside the vehicle during a predetermined period including a detection time point of the specific scene.

8. The information management apparatus according to claim 1, wherein
the microprocessor is further configured to perform:
the generating of the recording data including generating the recording data according to any one of a plurality of generation modes.

9. The information management apparatus according to claim 1, wherein
the microprocessor is further configured to perform:
starting the generating of the video data after a predetermined time has elapsed since a power supply of the vehicle is turned off.

10. The information management apparatus according to claim 1, wherein
the microprocessor is further configured to perform:
the generating of the additional information including generating the additional information using an LLM (large language model) with, as input, information indicating the specific scene detected.

11. An information management method for an information management apparatus comprising an imaging device configured to capture images of at least one of an interior of a vehicle and surroundings of the vehicle, and an audio input device provided in the interior of the vehicle, the method comprising:
generating video data including the image data and the audio data based on image data acquired by the imaging device and audio data acquired by the audio input device;
detecting, based on the image data or the audio data, a specific scene including a predetermined emotion of an occupant represented by at least one of a facial expression of the occupant in the interior of the vehicle and a voice uttered by the occupant;
generating additional information corresponding to the specific scene when the specific scene is detected; and
outputting recording data in which the video data and the additional information are associated with each other.

12. A computer-readable storage medium storing an information management program for causing a computer to execute the program, the computer comprising an imaging device configured to capture images of at least one of an interior of a vehicle and surroundings of the vehicle, and an audio input device provided in the interior of the vehicle, wherein
the information management program causes the computer to perform:
generating video data including the image data and the audio data based on image data acquired by the imaging device and audio data acquired by the audio input device;
detecting, based on the image data or the audio data, a specific scene including a predetermined emotion of an occupant represented by at least one of a facial expression of the occupant in the interior of the vehicle and a voice uttered by the occupant;
generating additional information corresponding to the specific scene when the specific scene is detected; and
outputting recording data in which the video data and the additional information are associated with each other.
